(19) United States
(12) Patent Application Publication
(10) Pub. No.: US 2019/0037807 A1
(43) Pub. Date: Feb. 7, 2019

(54) PET LASER TOY

(71) Applicant: RADIO SYSTEMS CORPORATION, Knoxville, TN (US)

(72) Inventors: Amanda Sweetnam, Knoxville, TN (US); Liu Feng, Knoxville, TN (US); Jacky Li, Knoxville, TN (US)

(21) Appl. No.: 15/666,225

(22) Filed: Aug. 1, 2017

(51) Int. Cl. A01K 15/02; F21V 33/00

(52) U.S. Cl. CPC A01K 15/025; F21Y 2115/30; F21V 33/008

(57) ABSTRACT

A toy a pet laser toy 100 includes a housing 101 having a front end 104 and a rear end 105 relative to the forward direction of travel. The toy has a right wheel 107 coupled to a right motor 110 and a left wheel 108 coupled to a left motor 111. The motors are independently controlled through a microprocessor 118. The toy 100 also includes a light source 126 mounted to the housing 101 at a downward angle with respect to the horizontal plane underlying the toy. With the angular mounting of the light source 126, the light produced by the light source 126 is projected upon the underlying support surface a short distance behind the rear end 105 of the toy 100.

### TECHNICAL FIELD

The present disclosure relates to the use of light projection in the design and manufacture of pet toys.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Cat play and toys incorporate predatory games of “play aggression”. Cats' behaviors when playing are similar to hunting behaviors. These activities allow kittens and younger cats to grow and acquire cognitive and motor skills, and to socialize with other cats. Cat play behavior can be either solitary (with toys or other objects) or social (with animals and people). They may play with a multitude of toys including strings, small furry toys resembling what would be prey (e.g. mice), and/or moving objects.

### INCORPORATION BY REFERENCE

Each patent, patent application, and/or publication mentioned in this specification is herein incorporated by reference in its entirety to the same extent as if each individual patent, patent application, and/or publication was specifically and individually indicated to be incorporated by reference.

### BRIEF DESCRIPTION OF THE DRAWINGS

So that the manner in which the present disclosure can be better understood, certain illustrations are appended hereto. It is to be noted, however, that the drawings illustrate only selected embodiments of a pet laser toy and are therefore not to be considered limiting of scope, for the embodiments may admit to other equally effective embodiments and applications.

FIG. 1 is a perspective view of a pet laser toy, under one embodiment.

FIG. 2 is a side view of a pet laser toy, under one embodiment.

FIG. 3 is a bottom view of a pet laser toy, under an embodiment.

FIG. 4 shows trajectories of a pet laser toy, under an embodiment.

FIG. 5 shows a rear view of a pet laser toy, under an embodiment.

FIG. 6 shows a top down view of a pet laser toy, under an embodiment.

### DETAILED DESCRIPTION

Pet animals including cats are naturally attracted to and are likely to chase moving points of light and/or light projected images. Therefore, pet owners may exercise and entertain their pets using light emitting pet toys. For example, a pet toy might include a light source from a laser, laser diode, or Light Emitting Diode (LED) that projects a beam of light onto an opaque surface such as a floor, wall or some other object.

The pet owners may want to exercise their pets for limited periods of time with such a pet toy. Accordingly, the pet toy may incorporate an automatic shut off whereby the toy automatically turns the unit off after a preset time adjustable by the pet owner. The toy may also have a built-in timer so that the pet toy turns on/off automatically according to a timer, whereby the pet owner sets the time or times in preset intervals. Pet toys may include other means for activating a toy such as motion, light, heat or other types of sensors.

A problem associated with pets toys is that the motion of the toy may actually scare the pet if the toy moves towards the animal. A pet toy is described herein that minimizes/eliminates the possibility of the toy moving towards the animal. The disclosed pet toy engages the pet's attention while minimizing the possibility of the toy directly approaching the pet.

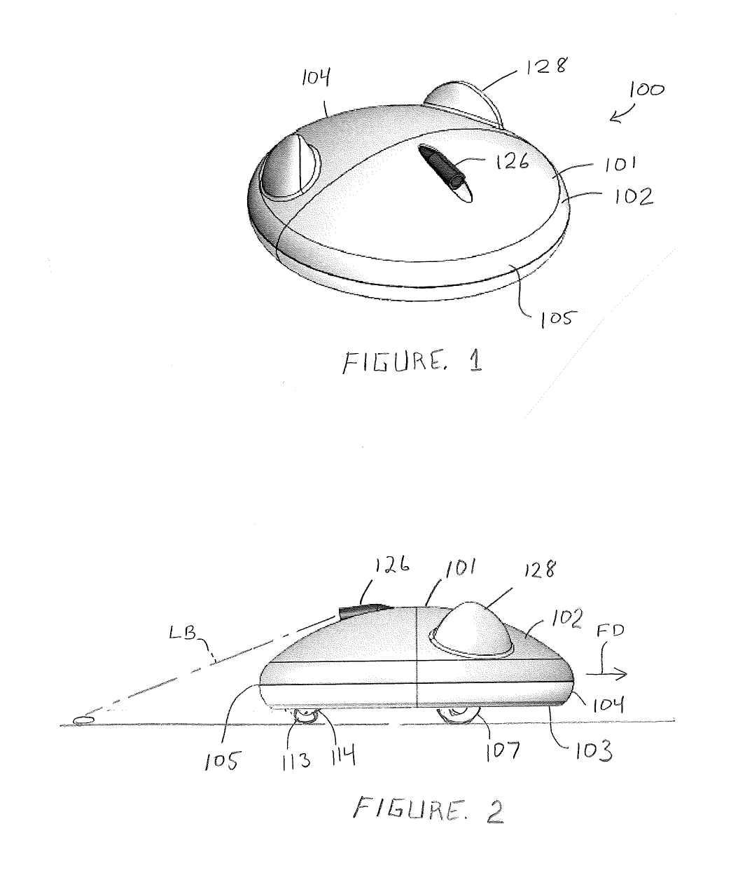

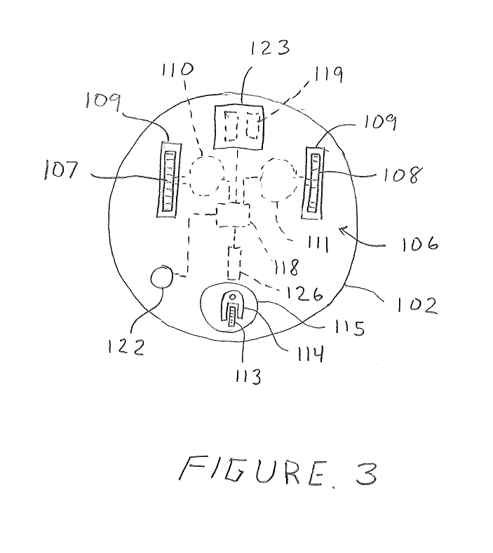

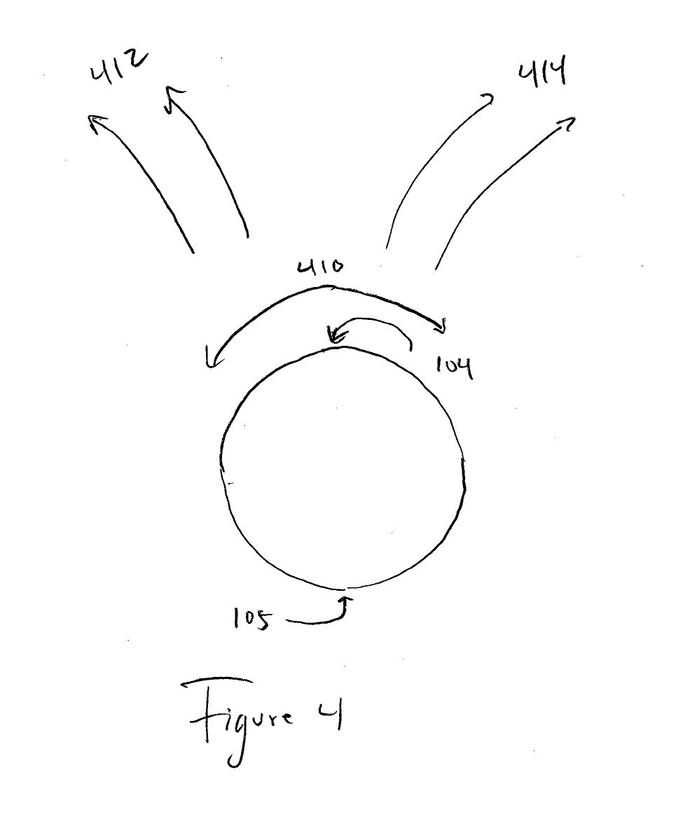

FIGS. 1-3 are views of a pet laser toy 100, under one embodiment.

The toy 100 includes a body or housing 101 having a generally round peripheral shape. The housing 101 has a top surface 102 and an oppositely disposed bottom surface 103. The housing 101 also has a front end 104 and a rear end 105 relative to the toy's forward direction FD of travel.

In the illustrated embodiment, the toy 100 has a drive mechanism 106 coupled to the housing 101. The drive mechanism 106 includes a first or right wheel 107 and a second or left wheel 108. The wheels 107 and 108 protrude from elongated slots 109 in the housing 101 so as to contact an underlying support surface, such as a floor. The right wheel 107 is coupled to the rotating shaft of a first or right electric motor 110. Similarly, the left wheel 108 is coupled to the rotating shaft of a second or left electric motor 111. The toy 100 also includes a rear wheel 113 which is coupled to the housing 101 through a freely rotating fork 114. The rear wheel 113 and fork 114 reside within a recess or depression 115 within the housing bottom surface 103.

The drive mechanism 106 also includes a microprocessor 118 which is electrically coupled to both the right electric motor 110 and the left electric motor 111. The microprocessor 118 is electrically coupled to a power source such as one or more D.C. batteries 119 through a conventional on/off switch 122. The batteries 119 may be accessible through a pivotal or removable cover 123 in the bottom surface 103 of the housing 101. The microprocessor 118 is programmed to actuate each motor 110 and 111 independently of the other. The microprocessor 118 may actuate the motors 110 and 111 to rotate in either direction, i.e., forward rotation or rearward rotation. The microprocessor program is designed to send electrical signals to actuate the motors with the appearance of the toy 100 moving forward in a seemingly or perceived generally random manner or path including moving forward, spinning right, spinning left, and/or turning right and turning left. The microprocessor 118 may not under one embodiment simultaneously actuate both motors 110 and 111 in reverse or a rearward rotation, thus avoiding the possibility of the toy 100 moving in a reverse or in a rearward direction.

The toy 100 also includes a light source 126 mounted to the top surface 102 of the housing 101. The light source 126 may be a laser, laser diode, LED or any other conventionally know visible light source. The light source 126 is coupled to the microprocessor 118. Alternatively, the light source 126 may be directly coupled to the on/off switch 122.

The light source 126 is mounted to the housing 101 at a downward angle with respect to the horizontal plane underlying the toy. With the angular mounting of the light source 126, the light or light beam LB produced by the light source 126 is projected or directed upon the underlying support surface a short distance behind the rear end 105 of the toy 100, such as 1 to 3 feet behind the toy with a preferred distance of approximately 2 feet.

The toy housing 101 may also include projections 128 or other attributes in order for the housing to take on more of the appearance of another animal. For example, the drawings show the projections 128 in a form to resemble animal ears. These projections also enhance the appearance should the housing 101 be painted or otherwise adorned to further the resemblance of another animal.

In use, the on/off switch 122 is actuated to an “on” position thereby powering the microprocessor 118 and the light source 126. The toy 100 is then placed upon an underlying surface, such as a floor, with the housing bottom surface 103 facing the floor.

The microprocessor 118 then actuates the right and left motors 110 and 111 to rotate the right and left wheels 107 and 108 (in a random, pseudo random, or preprogrammed manner). The right and left wheels 107 and 108 may both move forward, the right wheel 107 moving forward while the left wheel 108 moves rearward causing it to spin in one direction, and the right wheel 107 moving rearward while the left wheel 108 moves forward to cause it to spin in an opposite direction. The wheels 107 and 108 may also be actuated so that the right wheel 107 moves forward while the left wheel 108 does not move causing the toy to turn in one direction; and actuated so that the right wheel 107 does not move while the left wheel 108 moves forward causing the toy to turn in an opposite direction. The microprocessor may control right/left motors/wheels to move the toy along a right oriented or left oriented parabolic trajectory.

As seen in FIG. 4, the toy may rotate/spin in the designated directions 410 and/or move along designated (or analogous) trajectories 412, 414. Note that toy 100 comprises front end 104 and back end 105. Programmed movement of the toy 100 may prevent its movement in a rearward direction.

Should the toy become positioned within the corner of a room or in another position wherein it temporarily becomes “stuck”, the spinning action may under one embodiment eventually point the toy 100 in a direction which frees it from this position. This feature is enhanced by the round peripheral configuration of the housing 101. If the toy runs into a wall, the toy may under an embodiment eventually change paths so that it moves away. If the toy flips over, it may eventually turn off automatically due to a 10 minute auto shut off feature.

With the light source 126 activated, the light or light beam LB therefrom is projected onto the floor behind the rear end 105 of the toy, or rearward of the toy's direction of travel. Angling the light source 126 insures that the light appears relatively close to the toy 100 to peak the animals attention.

It is critical to understand that the light beam LB from the light source 126 always projects a point of light that follows behind or trails the toy 100. The reason for this important feature is so that the animal chasing the light is typically positioned away from the forward direction of travel for the toy 100. By positioning the animal behind the toy 100, the toy does not be move towards the animal, which may scare the animal and defeat the intended purpose of entertaining the animal. As such, the light is projected rearwardly and away from the toy's forward direction of travel 100. The assurance of a rearward projection of the light is a benefit over the prior art devices which randomly project light or which may move towards the animal in a perceived threatening manner.

The toy only moves forward with the laser tail behind the toy so as not to “run over” the cat who is chasing the “dot.” When the toy becomes stuck or runs into something, the toy may rotate right or left and then continue forward, and does not drive in reverse. Under an embodiment, the laser remains stationary within the housing and the “dot” does not move in any patterns in relation to the housing. The movement of the “dot” is under an embodiment only caused by the movement of the housing across the floor. Under an alternative embodiment, the laser may move in directions independently of the toy's motion.

The program of the microprocessor 118 may include a timer which turns the toy “off” after a designated time period.

Also, the toy 110 may include motion sensors to sense obstacles within the way of the toy during movement. Such motion sensors may sense the position of walls, furniture, or even the animal to further prevent scaring it during play.

The toy 110 may also include wireless signal receiving capabilities, such as wifi or Bluetooth signals, so that a person may wirelessly control the directional movement of the toy through a smart phone, pda, or remote control device.

The housing of the toy may comprise an ASM plastic housing. The toy may comprise a Printed Circuit Board Assembly (PCBA).

Lastly, the drive mechanism 106 may be in other conventionally known forms, such as a wind-up or spring loaded drive rather than the electronic form shown in the preferred embodiment.

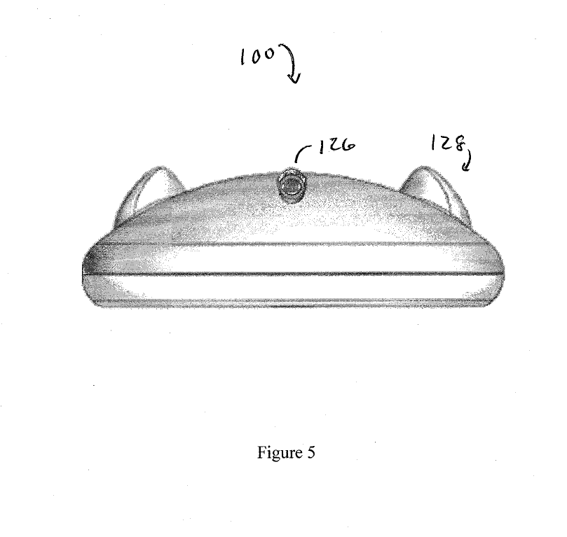

FIG. 5 shows a rear view of a pet laser toy, under an embodiment.

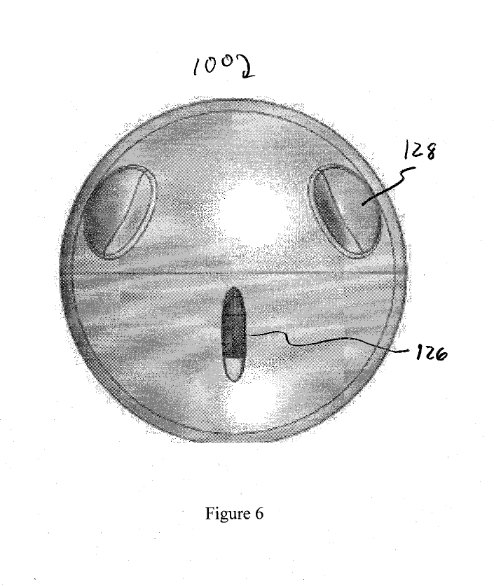

FIG. 6 shows a top down view of a pet laser toy, under an embodiment.

It will be appreciated that the embodiments described herein are susceptible to modification, variation and change without departing from the spirit thereof.

A pet toy comprises under an embodiment a housing, at least one wheel, an electric motor coupled to said at least one wheel, and a power source electrically coupled to said electric motor. Said at least one wheel, electric motor and power source drive said pet toy in a forward direction of travel. A light source is electrically coupled to said power source and coupled to said housing, said light source being positioned to direct a beam of light in a rearward direction generally opposite to the forward direction of travel.

Said light source is angled under an embodiment to project the beam of light downwardly behind the pet toy.

The pet toy comprise under an embodiment a microprocessor coupled to said electric motor, said microprocessor providing electric signals to said electric motor to control the direction of travel of said toy.

Said microprocessor provides under an embodiment said electric signals to said electric motor to produce a perceived random direction of travel.

Said light source is a laser diode, under an embodiment.

Said light source projects a light beam at a downward angle upon an underlying surface between one foot and three feet from said toy, under an embodiment.

Said at least one wheel includes two wheels and wherein each said wheel is coupled to said electric motor, wherein the two wheels may be driven in opposite directions to impart a spinning motion, under an embodiment.

A pet toy comprises under an embodiment a housing having a front end relative to the direction of travel of said pet toy and a rear end oppositely disposed from said front end. The pet toy comprises a first wheel, a second wheel, a first electric motor coupled to said first wheel, and a second electric motor coupled to said second wheel. The pet toy comprises a power source electrically coupled to said first and second electric motor. The pet toy comprises a microprocessor electrically coupled to said power source, said first electric motor and said second electric motor, said microprocessor controlling the directional actuation of said first and second electric motors. The pet toy comprises a light source electrically coupled to said power source, said light source being positioned to direct a beam of light in a rearward direction onto an underlying support surface adjacent said rear end of said housing.

Said microprocessor provides under an embodiment electric signals to said first and second motors to produce a perceived random forward direction of travel.

Said light source is a laser diode, under an embodiment.

Said light source projects under an embodiment a light beam at a downward angle upon an underlying surface between one foot and three feet from said toy.

A pet toy of an embodiment comprises a body, a drive mechanism for propelling the pet toy in a generally forward direction, and a light source mounted on said body and electrically coupled to a power source, said light source directing a beam of light in a rearward direction generally opposite to the forward direction.

Said light source is under an embodiment angled to project the beam of light downwardly behind the pet toy.

Said drive mechanism propels the pet toy in a seemingly random path, under an embodiment.

Said drive mechanism under an embodiment includes a first wheel, a second wheel, a first electric motor coupled to said first wheel, a second electric motor coupled to said second wheel, a power source electrically coupled to said first and second electric motor, and a microprocessor electrically coupled to said power source, said first electric motor and said second electric motor, said microprocessor controlling the directional actuation of said first and second electric motors.

Said light source is a laser diode, under an embodiment.

Said light source projects a light beam at a downward angle upon an underlying surface between one foot and three feet from said toy, under an embodiment.

For purposes of the present disclosure, it is noted that spatially relative terms, such as “up,” “down,” “right,” “left,” “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over or rotated, elements described as “below” or “beneath” other elements or features would then be oriented “above” the other elements or features. Thus, the exemplary term “below” can encompass both an orientation of above and below.

We claim:

1. A pet toy comprising:
a housing;
at least one wheel;
an electric motor coupled to said at least one wheel;
a power source electrically coupled to said electric motor;
said at least one wheel, electric motor and power source driving said pet toy in a forward direction of travel; and
a light source electrically coupled to said power source and coupled to said housing, said light source being positioned to direct a beam of light in a rearward direction generally opposite to the forward direction of travel.

2. The pet toy of claim 1, wherein said light source is angled to project the beam of light downwardly behind the pet toy.

3. The pet toy of claim 1, comprising a microprocessor coupled to said electric motor, said microprocessor providing electric signals to said electric motor to control the direction of travel of said toy.

4. The pet toy of claim 3, wherein said microprocessor provides said electric signals to said electric motor to produce a perceived random direction of travel.

5. The pet toy of claim 1, wherein said light source is a laser diode.

6. The pet toy of claim 1, wherein said light source projects a light beam at a downward angle upon an underlying surface between one foot and three feet from said toy.

7. The pet toy of claim 1, wherein said at least one wheel includes two wheels and wherein each said wheel is coupled to said electric motor,
wherein the two wheels may be driven in opposite directions to impart a spinning motion.

8. A pet toy comprising:
a housing having a front end relative to the direction of travel of said pet toy and a rear end oppositely disposed from said front end;
a first wheel;
a second wheel;
a first electric motor coupled to said first wheel;
a second electric motor coupled to said second wheel;
a power source electrically coupled to said first and second electric motor;
a microprocessor electrically coupled to said power source, said first electric motor and said second electric motor, said microprocessor controlling the directional actuation of said first and second electric motors; and
a light source electrically coupled to said power source, said light source being positioned to direct a beam of light in a rearward direction onto an underlying support surface adjacent said rear end of said housing.

9. The pet toy of claim 8, wherein said microprocessor provides electric signals to said first and second motors to produce a perceived random forward direction of travel.

10. The pet toy of claim 8, wherein said light source is a laser diode.

11. The pet toy of claim 8, wherein said light source projects a light beam at a downward angle upon an underlying surface between one foot and three feet from said toy.

12. A pet toy comprising:
a body;
a drive mechanism for propelling the pet toy in a generally forward direction;
a light source mounted on said body and electrically coupled to a power source, said light source directing a beam of light in a rearward direction generally opposite to the forward direction.

13. The pet toy of claim 12, said light source angled to project the beam of light downwardly behind the pet toy.

14. The pet toy of claim 12, wherein said drive mechanism propels the pet toy in a seemingly random path.

15. The pet toy of claim 12, wherein said drive mechanism includes:
a first wheel;
a second wheel;
a first electric motor coupled to said first wheel;
a second electric motor coupled to said second wheel;
a power source electrically coupled to said first and second electric motor; and
a microprocessor electrically coupled to said power source, said first electric motor and said second electric motor, said microprocessor controlling the directional actuation of said first and second electric motors.

16. The pet toy of claim 12, wherein said light source is a laser diode.

17. The pet toy of claim 12, wherein said light source projects a light beam at a downward angle upon an underlying surface between one foot and three feet from said toy.
